(19) United States
(12) Patent Application Publication
(10) Pub. No.: US 2025/0259073 A1
(43) Pub. Date: Aug. 14, 2025

(54) REINFORCEMENT LEARNING THROUGH PREFERENCE FEEDBACK

(71) Applicant: DeepMind Technologies Limited, London (GB)

(72) Inventors: Mohammad Gheshlaghi Azar, London (GB); Zhaohan Guo, London (GB); Bilal Piot, London (GB); Mark Daniel Rowland, London (GB); Remi Munos, London (GB)

(21) Appl. No.: 18/441,920

(22) Filed: Feb. 14, 2024

(51) Int. Cl. G06N 3/092

(52) U.S. Cl. CPC G06N 3/092

(57) ABSTRACT

Methods, systems, and apparatus, including computer programs encoded on a computer storage medium, for training neural networks using a preference function that compares a measure of quality between network outputs. According to one aspect there is provided a method for training a target neural comprising: at each of a plurality of training steps, receiving one or more network inputs; for each of the network inputs, processing the network input using the target neural network to generate a first network output, processing the network input using an alternative neural network for the training step to generate a second network output, and applying a preference function to the first and second network outputs to generate a preference score comparing the first and second network outputs; and updating the target neural network weights using an objective function that encourages the first network outputs to be preferred over the second network outputs.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes systems and methods implemented as computer programs on one or more computers in one or more locations that can train neural networks using a preference function that compares a measure of quality between network outputs.

According to a first aspect there is provided a method performed by one or more computers and for a training a target neural network that has a plurality of target neural network weights and is configured to process a network input in accordance with the target neural network weights to generate a network output. At each of a plurality of training steps, the method includes receiving one or more network inputs. For each of the network inputs, the method includes processing the network input using the target neural network to generate a first network output, processing the network input using an alternative neural network for the training step to generate a second network output, and applying a preference function to the first network output and the second network output to generate a preference score that indicates a likelihood that the first network output is a higher quality output than the second network output. For each training step, the method includes updating the target neural network weights using an objective function that includes a first term that encourages the first network outputs to be preferred over the corresponding second network outputs according to the preference scores.

In some implementations, the method further includes, at each of the plurality of training steps and for each of the one or more network inputs, (i) determining a first likelihood score assigned to the first network output by the target neural network given the network input and (ii) determining a second likelihood score assigned to the first network output by a reference neural network for the training step given the network input, and the objective function includes a second term that penalizes the target neural network for generating first likelihood scores that deviate from corresponding second likelihood scores.

In some implementations, at each of the plurality of training steps, the reference neural network for the training step is the alternative neural network for the training step.

In some implementations, applying the preference function to the first network output and the second network output to generate the preference score that indicates the likelihood that the first network output is a higher quality output than the second network output includes: (i) processing the first network output and the second network output using a preference model neural network to generate a preference network output, where the preference model neural network is trained to process pairs of neural network outputs and generate a corresponding preference network output for each processed pair of neural network outputs that indicates a likelihood that one member of the processed pair is a higher quality output than the other member of the processed pair and (ii) generating, based on the preference network output, the preference score that indicates the likelihood that the first network output is a higher quality output than the second network output.

In some implementations, at each of the plurality of training steps and for each of the one or more network inputs, determining the second likelihood score assigned to the first network output by a reference neural network for the training step given the network input includes: determining the second likelihood score assigned to the first network output based on a geometric mixture of the first likelihood score for the first network output and of a likelihood score for the first network output under a fixed reference distribution and based on a normalizing constant for the training step.

In some implementations, at each of the plurality of training steps, the alternative neural network for the training step has a plurality of alternative neural network weights for the training step and has the same architecture as the target neural network and the alternative neural network weights for the training step are determined by an exponential moving average of the target neural network weights over the current and previous training steps.

In some implementations, objective function is based on, for each network input and corresponding first and second network outputs: a preference score, as determined by the preference function, indicating a likelihood that the first network output is a higher quality output than the second network output; a first likelihood score for the first network output, as determined by the target neural network; and a second likelihood score for the first network output, as determined by a fixed reference distribution.

In some implementations, updating the current target neural network weights using the objective function that includes a first term that encourages first network inputs to be preferred over corresponding second network inputs according to the preference scores includes: determining a gradient of the objective function with respect to the target neural network weights and updating the target neural network weights based on the gradient of the objective function.

In some implementations, determining the gradient of the objective function with respect to the current target neural network weights includes computing for each network input and corresponding first and second network outputs: a gradient of a first likelihood score for the first network output, as determined by the target neural network, with respect to the current target neural network weights; and a preference score, as determined by the preference function, indicating a likelihood that the first network output is a higher quality output than the second network output; the first likelihood score for the first network output, as determined by the target neural network; and a likelihood score for the first network output, as determined by a fixed reference distribution.

In some implementations, the target neural network is a large language model.

In some implementations, the preference neural network is a large language model.

In some implementations: the first network output is a first network output sequence; the second network output is a second network output sequence; and processing the network input using the alternative neural network to generate the second network output includes autoregressively generating the second network output sequence using the alternative neural network.

In some implementations, at each of the plurality of training steps and for each of the one or more network inputs, determining the second likelihood score assigned to the first network output by a reference neural network for the training step given the network input includes: for each output element of the first network output sequence, determining a first likelihood score for the output element given the network input using the target neural network and determining a second likelihood score for the output element based on a geometric mixture of the first likelihood score for the output element and of a likelihood score for the output element under a fixed reference distribution and based on a normalizing constant for the training step; and determining the second likelihood score assigned to the first network output based on the second likelihood scores of the output elements in the first network output sequence.

In some implementations, the preference function can model a non-transitive preference relation.

According to another aspect, there is provided a system that includes one or more computers and one or more storage devices communicatively coupled to the one or more computers and storing instructions that, when executed by the one or more computers, cause the one or more computers to perform operations of the previously described method.

According to another aspect, there is provided one or more non-transitory computer storage media storing instructions that when executed by one or more computers cause the one or more computers to perform operations of the previously described method.

Particular embodiments of the subject matter described in this specification can be implemented so as to realize one or more of the following advantages.

The described systems can use a pair-wise preference function to train the target neural that processes a pair of network outputs to determine a preference score. In some implementations, the described systems can train a preference model to model the pair-wise preference function. Unlike conventional methods for training neural networks based on preferences, which often rely on fitting a reward model to assign numerical values to individual network outputs that align with the preferences, the described systems can model non-transitive preferences. By using a pair-wise preference function, the described systems can also more accurately model transitive preferences than conventional methods. The described systems can therefore accurately train neural networks based on preferences for a wider range of applications (e.g., modeling human preferences, predicting outcomes of competitive games, etc.) than conventional methods.

By using the pair-wise preference function to more accurately model preferences for the conditional generation task, the described systems can train the target neural network to attain a particular threshold of performance in the conditional generation task (e.g., as determined based on the preference function) in fewer training iterations than conventional methods. The described systems can therefore train neural networks based on preferences more efficiently (e.g., with respect to training time, computational resources, etc.) than conventional methods.

Conventional methods often train neural networks to optimize reward models that have been fit based on preference data and can be susceptible to reward hacking, in which the network outputs that maximize rewards under the reward model are not preferred to network outputs that receive worse rewards. In contrast, the described systems can train the target neural networks to approach a Nash equilibrium of the preferences with respect to a set of alternative neural networks (e.g., to produce network outputs that are at least as preferred compared to the network outputs produced by the set of alternative neural networks).

In particular, the described systems can train the target neural networks by comparing outputs from the target neural networks and corresponding outputs of the alternative neural networks. The described systems can use an objective function that includes a term that indicates preferences of the target neural network outputs as compared to corresponding alternative neural network output. While training the target neural networks, the described systems can update the alternative neural networks at each training step based on the training of the target neural networks. By comparing preferences for the target neural network outputs over corresponding network outputs from alternative neural networks updated at each training step, objective function of the described systems can encourage the target neural networks to approach a Nash equilibrium of the preferences with respect to a set of alternative neural networks. By training the target neural networks to approach a Nash equilibrium of the preferences, the described systems can be less susceptible to reward hacking compared to traditional methods.

The described systems can also regularize the training of the target neural network with respect to a reference neural network. In particular, the described systems can use an objective function that includes a term that penalizes the target neural network from differing too greatly from the reference neural network. For example, the reference neural network can produce known safe or desirable outputs and the described system can train the target neural network based on the preferences while producing outputs similar to those of the reference neural network.

The described system can therefore enable more accurate and efficient training of neural networks based on preferences while ensuring that the target neural network can produce preferred outputs.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example training system.

FIG. 2 is a block diagram of an example target neural network.

FIG. 3 is a flow diagram of an example process for training a target neural network.

FIG. 4 is a flow diagram of an example process for training a preference model neural network.

FIG. 5 is a flow diagram of an example process for determining an objective function for a training step.

Like reference numbers and designations in the various drawings indicate like elements.

### DETAILED DESCRIPTION

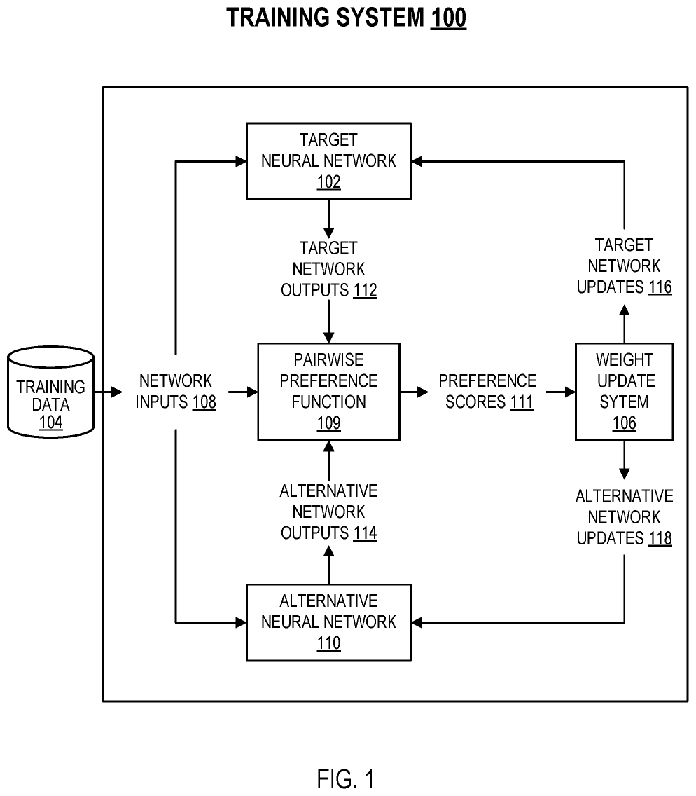

FIG. 1 shows an example training system 100. The training system 100 is an example of a system implemented as computer programs on one or more computers in one or more locations in which the systems, components, and techniques described below are implemented.

The training system 100 can train a target neural network 102 using a set of training data 104 to perform a conditional generation task. In particular, the system 100 can train the target neural network 102 to perform the conditional generation task as aligned with preferences for the task. The target neural network 102 has a set of target neural network weights that include, e.g., the weights and, optionally, the biases of the layers of the target neural network. The target neural network 102 can be a neural network trained (e.g., pre-trained) to perform the conditional generation task and the system 102 can further train (e.g., fine-tune) the target neural network 102 to perform the conditional generation task as aligned with preferences for the task.

The training system 100 includes a weight update system 106 that can, over a series of training steps, update the target neural network weights to train the target neural network 102. At each training step, the training system 100 can train the target neural network 102 to perform the conditional generation task on a set (e.g., a mini-batch) of network inputs 108.

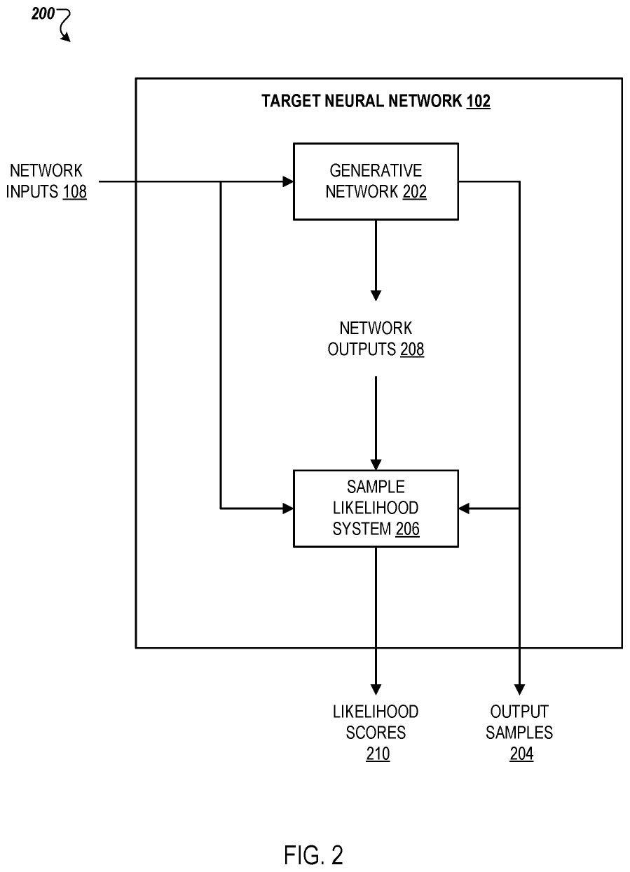

The target neural network 102 can be any generative model suited to generating output samples based on the network inputs 108. The target neural network 102 is described in more detail below with reference to FIG. 2.

The conditional generation task can be any of a variety of tasks. As an example, the network inputs 108 can be text prompts and the conditional generation task can be to generate output samples as described by the text prompts. As a further example, the target neural network 102 can be configured to output, e.g., sample images, sample videos, sample audio, etc., as described by text prompts from the network inputs 108.

The conditional generation task can be a style transfer task to match a style of, e.g., images, video, audio, etc., specified by the network inputs 108. For example, the target neural network 102 can be configured to output, e.g., sample images, sample videos, sample audio, etc., that match styles of the network inputs 108.

The conditional generation task can be a transcription task in which the target neural network 102 is configured to produce text transcriptions for, e.g., video, audio, etc., specified by the network inputs 108.

The conditional generation task can be a summarization task in which the target neural network 102 is configured to produce text summaries of, e.g., text, images, video, audio, etc., specified by the network inputs 108.

The conditional generation task can be a natural language processing (NLP) task and the target neural network 102 can be a large language model configured to perform the language processing task. For example, the target neural network 102 can be configured to generate text responses to network inputs 108 provided by a user. As another example, the target neural network 102 can be configured to generate code for computer programs (e.g., in a programming language such as Python, Java, C++, etc.) to perform tasks specified by the network inputs 108 provided by a user.

The conditional generation task can be an action selection task for an agent interacting with an environment. For example, the network inputs 108 can be, e.g., sensor data for the agent, observed trajectories of other agents within the environment, etc., that characterize observations of the environment and the target neural network 102 can be configured to sample actions for the agent based on observations of the environment. As a further example, the network inputs 108 can be, e.g., LIDAR data, camera data, etc., collected for an autonomous vehicle and the target neural network 102 can be configured to select actions to control the autonomous vehicle. As another example, the network inputs 108 can characterize the state of a game and the target neural network 102 can be configured to select actions for a player of the game.

The training system 100 trains the target neural network 102 to perform the conditional generation task using a pairwise preference function 109. The pairwise preference function 109 can compare a given output sample from the target neural network 102 with a corresponding output sample from an alternative neural network 110 to generate a preference score 111 that indicates a likelihood that the output sample from the target neural network 102 is a higher quality output than the output sample from the alternative neural network 110.

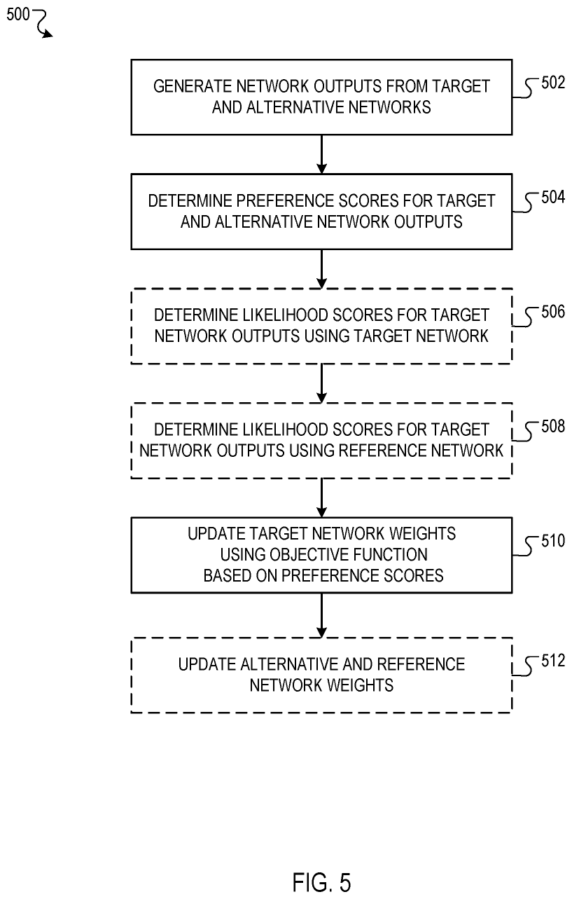

The alternative neural network 110 can be any of a variety of networks that can provide alternative (relative to the target neural network 102) output samples for the conditional generation task. Examples of the alternative neural network 110 are described below with reference to FIG. 5.

As an example, the preference score 111 can indicate whether an output sample from the target neural network 102 or a corresponding output sample from the alternative neural network 110 is more likely to be drawn from a ground truth distribution.

As another example, the preference score 111 can indicate whether an output sample from the target neural network 102 or a corresponding output sample from the alternative neural network 110 is more likely to have less, e.g., distortion, perceptual distortion, etc., for the conditional generation task.

As another example, the preference score 111 can indicate whether an output sample from the target neural network 102 or a corresponding output sample from the alternative neural network 110 is more likely to receive a greater reward for the conditional generation task.

As yet another example, the preference score 111 can quantify a human preference between an output sample from the target neural network 102 and a corresponding output sample from the alternative neural network 110.

In particular, the preference function 109 can model non-transitive preferences between network outputs. Namely, for network outputs A, B, and C, when the preference function determines that A is preferrable to (i.e., more likely to be a higher quality output than) B and that B is preferable to C, and the preference function 109 can determine that C is preferable to A. In the above example, a model restricted to modeling transitive preferences would necessarily determine that A is preferable to C. Non-transitive preferences can be found in a variety of applications (e.g., modeling human preferences, predicting the performance of players in a competitive game, etc.). The preference function 109 can therefore accurately model preferences for a wider range of applications compared to models restricted to modeling transitive preferences.

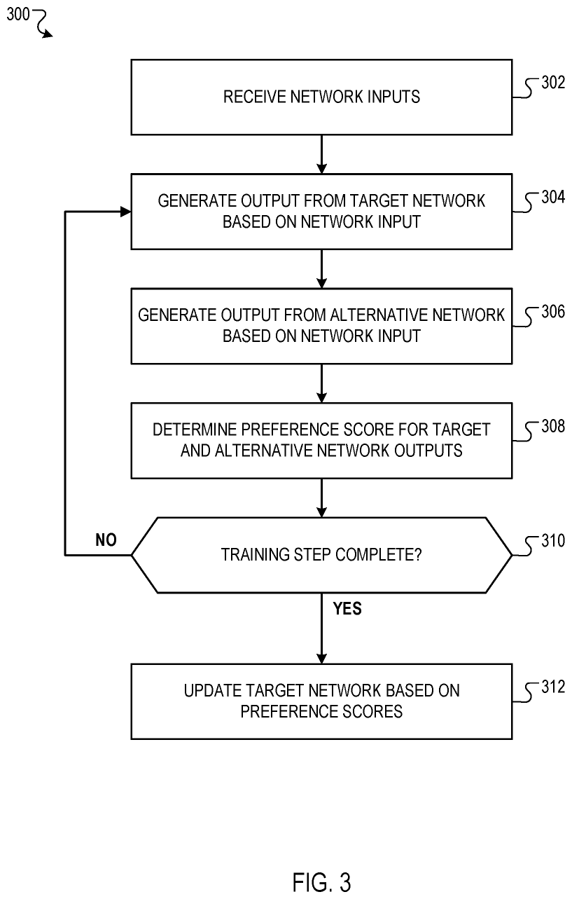

At each training step, the system 102 uses the pair-wise preference function 109 to compare target network outputs 112, which include output samples from the target neural network 102, with corresponding alternative network outputs 114, which include output samples from the alternative neural network 110, to generate preference scores 111 for the training step. Based on the preference scores 111, the weight update system 106 generates updates 116 for the target neural network 102 weights and updates 118 for the alternative neural network 110. The weight update system 106 can generate the weight updates 116 and 118 so as to train the target neural network 102 to perform the conditional generation task. The process of training the target neural network 102 is described in more detail below with reference to FIG. 3.

FIG. 2 shows an example target neural network 102.

The target neural network 102 includes a generative model 202 that can process the network inputs 108 and generate output samples 204 to perform a conditional generation task.

The generative model 202 can have any appropriate architecture for processing the network inputs 108 and generating the output samples 204 to perform the conditional generation task. As an example, the generative model 202 can be an auto-regressive generative model (e.g., a Transformer, a recurrent neural network, etc.) that can auto-regressively generate sequence as the output samples 204 based on the network inputs 108. The generative model can, for example, be a large language model (LLM) that can auto-regressively generate tokenized representations of text data, a vision-language model (VLM) that can auto-regressively generate tokenized representations of image or video data, an audio language model that can auto-regressively generate tokenized representations of text data, and so on.

As another example, the generative model 202 can be a diffusion model (e.g., a denoising diffusion model, a score-based diffusion model, a latent diffusion model, etc.) that can generate the output samples 204 by repeatedly transforming samples from a noise distribution (e.g., a Gaussian distribution) based on the network inputs 108 over a sequence of iterations. For example, the generative model 202 can be a diffusion model that transforms samples from the noise distribution using a denoising neural network with any appropriate architecture (e.g., a convolutional neural network, a recurrent neural network, etc.).

As another example, the generative model 202 can be a neural network that can generate the output samples 204 by transforming samples from a noise distribution (e.g., a Gaussian distribution). The generative model 202 can be, e.g., a generator network of a generative adversarial network, a decoder of a variational auto-encoder, a normalizing flow, and so on.

The generative model 202 can generate network outputs 208 that define respective conditional probabilities or likelihoods of the output samples 204 given the corresponding network inputs 108. For example, the network outputs 208 can include conditional probabilities for a set of values for each of the output samples 204 given the corresponding network inputs. As another example, the network outputs 208 can determine statistical properties (e.g., means, variances, etc.) regarding conditional distributions for each of the output samples 204 given the corresponding network inputs 108. As another example, the generative model 202 can include a plurality of processing layers and a plurality of layer activation functions and the network outputs 208 can include output values from the processing layers and layer activation functions resulting from the generative model 202 processing the corresponding network inputs 108.

The target neural network 102 can include a sample likelihood system 206. The sample likelihood system 206 can process the data specifying the conditional distributions 208 to generate likelihood scores 210 that specify likelihoods of each of the output samples 204 under the conditional distributions 208 given the corresponding network inputs 108.

The likelihood scores 210 can be any of a variety of numerical values that indicate conditional probabilities of likelihoods of the output samples 204 given the corresponding network inputs 108. For example, the likelihood scores 210 can be the conditional probabilities or likelihoods of the output samples 204 given the corresponding network inputs 108. As another example, the likelihood scores 210 can be transformations of the conditional probabilities or likelihoods (e.g., log-probabilities, log-likelihoods, negative log-likelihoods, unnormalized values, etc.) of the output samples 204 given the network inputs 108. As another example, the sample likelihood system 206 can determine auxiliary distributions that approximate conditional distributions of the output samples 204 given the corresponding network inputs 108 and the likelihood scores 210 can be probabilities or likelihoods of the output samples 204 under the auxiliary distributions.

The sample likelihood system 206 can determine the likelihood scores 210 based on the network outputs 208 by any of a variety of methods. For example, the network outputs 208 can include sets of conditional probabilities of the outputs samples 204 and the sample likelihood system can return the conditional probabilities of the output samples 204 as the likelihood scores 210. As another example, the network outputs 208 can include data specifying conditional distributions for the output samples 204 and the sample likelihood system 206 can return the likelihoods of the output samples 204 under the specified conditional distributions as the likelihood scores 210. As another example, the network outputs 208 can include data specifying conditional distributions for the output samples 204 and the sample likelihood system 206 can determine and return approximate likelihoods of the output samples 204 under the specified conditional distributions as the likelihood scores 210. As a particular example, the network outputs 208 can include data specifying layer outputs from the generative model 202 and the sample likelihood system can determine approximate likelihoods (e.g., by determining approximations of the conditional distributions, using importance weights, etc.) to return as the likelihood scores 210. As another particular example, the sample likelihood system 206 can include a neural network trained to approximate conditional distributions of the output samples 204 given the network inputs 108 and can process the network inputs 108 to determine approximate likelihoods of the output samples 204 to return as the likelihood scores 210.

FIG. 3 is a flow diagram of an example process for training a target neural network to perform a conditional generation task. For convenience, the process 300 will be described as being performed by a system of one or more computers located in one or more locations. For example, a training system, e.g., the training system 100 of FIG. 1, appropriately programmed in accordance with this specification, can perform the process 300.

The training system can train the target neural network over a plurality of training steps.

At each training step, the training system can receive a set of one or more network inputs for the training step (step 302). For example, the system can receive a mini-batch of network inputs from a set of training data.

The system can process the network inputs for the training step using the target neural network to generate corresponding network outputs (step 304). In particular, the target neural network can process each of the network inputs to generate a corresponding output sample to perform the conditional generation task.

The system can process the network inputs for the training step using an alternative neural network for the training step to generate corresponding network outputs (step 306). In particular, the alternative neural network can process each of the network inputs to generate a corresponding output sample to perform the conditional generation task.

For each of the network inputs, the system can apply a preference function to the corresponding network outputs from the target and alternative neural networks to determine a preference score that compares the network outputs (step 308). For each pair of network outputs from the target and alternative neural networks, the preference score indicates a likelihood that the network output from the target neural network is a higher quality output than the network output from the alternative neural network.

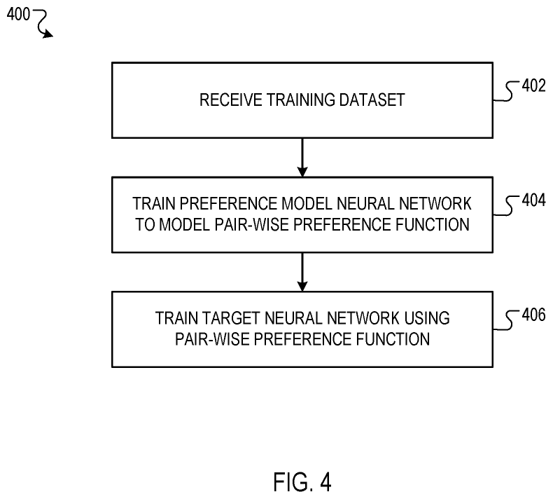

In some implementations, the preference function is a preference model neural network. The preference model neural network can be trained to process pairs of neural network outputs and generate a corresponding preference network output for each processed pair of neural network outputs that indicates a likelihood that one member of the processed pair is a higher quality output than the other member of the processed pair. An example process for training the preference model neural network is described in more detail below with reference to FIG. 4.

The system can determine whether the training step is complete (step 310). For example, the system can determine that the training step is complete when the system has processed all of the network inputs in the set of network inputs. If the training step is not complete, the system can process a next network input for the training step.

When the training step is complete, the system can update the target neural network weights based on the preference scores determined for the training step (step 312). In particular, the system can update the target neural network weights using an objective function for the training step that includes a term that encourages the network outputs from the target neural network to be preferred over corresponding network outputs from the alternative neural network according to the preference scores. An example objective function for the training step is described in more detail below with reference to FIG. 5.

FIG. 4 is a flow diagram of an example process for training a preference model neural network. For convenience, the process 400 will be described as being performed by a system of one or more computers located in one or more locations. For example, a training system, e.g., the training system 100 of FIG. 1, appropriately programmed in accordance with this specification, can perform the process 400.

The system receives a set of training data (step 402). The training data includes example network inputs for training the target neural network to perform the conditional generation task. The training data can include data that specifies a preference function for network outputs. For example, the training data can include, for each example network input, a pair of example network outputs and a corresponding indication that one network output of the pair is a higher quality output than the other. As a particular example, the training data can include, for each pair of example network outputs, a target likelihood that network output of the pair is a higher quality output than the other output of the pair. As another particular example, the training data can include, for each pair of example network outputs, a target classification of which network output of the pair is a higher quality output.

The system trains the preference model neural network to model the preference function specified by the training data (step 404). As described above, the system can train the preference model neural network to process pairs of neural network outputs and generate a corresponding preference network output for each processed pair of neural network outputs that indicates a likelihood that one member of the processed pair is a higher quality output than the other member of the processed pair. As an example, the system can train the preference model neural network to replicate the target likelihoods from the training dataset by optimizing a regression loss function (e.g., an L2 loss) between the preference network outputs and corresponding target likelihoods. As another example, the system can train the preference model neural network to replicate target classifications for pairs of network outputs by optimizing a classification loss function (e.g., a cross-entropy loss) between the preference network outputs and corresponding target classifications.

The preference model neural network can have any of a variety of network architectures suited to processing pairs of network outputs. For example, if the network outputs are images, the preference model neural network can include neural networks suited to processing image data (e.g., convolutional neural networks, vision transformers, etc.). As anther example, if the network outputs are sequences of values (e.g., time-series data, text sequences, video sequences, audio sequences, etc.), the preference model neural network can include neural networks suited to processing sequences (e.g., recurrent neural networks, transformer networks, etc.). As a particular example, the preference model neural network can be a large language model.

The system can train the preference model neural network to model any of a variety of preference functions for network outputs. For example, for each pair of network outputs, the preference function can indicate a likelihood that one network output of the pair has a higher quality than the other, as determined by some measure of quality. As a further example, the preference function can indicate a likelihood that one output of the pair has a lower, e.g., distortion, perceptual distortion, and so on. As another further example, when the network outputs are actions for an agent interacting with an environment, the preference function can indicate a likelihood that one output of the pair will receive a greater reward.

The preference function can represent preferences of a human or a group of humans. For example, the preference function can indicate, for each pair of network outputs, a human preference for one of the network outputs as the higher quality output of the pair. As another example, the preference function can indicate a human belief or certainty for one of the network outputs as being more likely to be the higher quality output of the pair.

In particular, the preference function can be a non-transitive preference function. For example, if y₁, y₂, and y₃ are network outputs, the preference function can indicate that a human prefers y₁ to y₂, prefers y₂ to y₃, but also prefers y₃ to y₁. As another example, if the network outputs represent actions to be performed by agents interacting in an environment, the preference function can indicate a non-transitive likelihood of success of the output actions when performed by competing agents.

As described above, the system can then train the target neural network to perform the conditional generation task using the training dataset and the trained preference model neural network (step 406).

FIG. 5 is a flow diagram of an example process for determining an objective function for training a target neural network to perform a conditional generation task. For convenience, the process 500 will be described as being performed by a system of one or more computers located in one or more locations. For example, a training system, e.g., the training system 100 of FIG. 1, appropriately programmed in accordance with this specification, can perform the process 500.

As described above, the system trains the target neural network over a sequence of training steps. At each training step, the system receives a set of network inputs.

The system processes the set of network inputs to generate a set of network outputs from the target neural network and a set of corresponding network outputs from an alternative neural network for the training step (step 502).

The alternative neural network for each time step can be determined based on the target neural network. As described above, the alternative neural network can be any of a variety of networks that can provide alternative (relative to the target neural network) output samples for the conditional generation task.

For example, the alternative neural network can be a network trained to perform the conditional generation task with a different network architecture compared to the target neural network. As another example, the alternative neural network can have the same network architecture as the target neural network. As a further example, the alternative neural network can have the same architecture as the target neural network with different hyperparameters (e.g., having been trained with different hyperparameters, performing inference using different hyperparameters, etc.), such as network sizes, network depths, numbers of inputs, learning rates, and so on. As a further example, the alternative neural network can be a reparameterization of the target neural network with different network weights or can be a copy of the target neural network as fine-tuned on a particular set of training data for the alternative neural network. As a further example, the alternative neural network can process modified network inputs compared to the target neural network (e.g., by conditionally generating network outputs based on modified neural network inputs that specify producing the outputs in a different style than the target neural network, by processing modified input prompts compared to the target neural network, etc.).

In particular, the alternative neural network can have the same network architecture as the target neural network and can have alternative neural network weights determined based on the target neural network weights at the current and previous training steps. As an example, the alternative neural network weights can be the target neural network weights from a previous time step (e.g., alternative neural network weights at the T-th training step, \hat{θ}_{T}, can be δ_{T-K}, the target neural network weights at the T-K-th time step).

As another example, the alternative neural network weights can be determined by a moving average of the target neural network weights at the current and previous training steps. Namely, the alternative neural network can model a conditional distribution p_{\hat{θ}′ (y|x), with the alternative neural network weights at the T-th training step, \hat{θ}}_{T}, being determined by the moving average:

$${\hat{θ}}_{T} = \frac{1}{K} {\sum }_{i = T - K + 1}^{T} {θ}_{i}$$

Where K>0 is a window length and where θᵢ are the target neural network weights at the i-th training step.

As another example, the alternative neural network weights can be determined by an exponential moving average of the target neural network weights at the current and previous training steps. Namely, the alternative neural network can model a conditional distribution p_{\hat{θ}′ (y|x), with the alternative neural network weights at the T-th training step, \hat{θ}}_{T}, being determined by the exponential moving average:

$${\hat{θ}}_{T} = {\sum }_{i = 0}^{T} {α}^{T - i} {θ}_{i}$$

Where α∈[0,1] is a weighting parameter and where θᵢ are the target neural network weights at the i-th training step.

The system processes each network output from the target neural network and corresponding network output from the alternative neural network for the time step using a pair-wise preference function to determine a preference score for the pair (step 504).

In some implementations, the system can determine a likelihood score for each network output according to the target neural network (step 506). The likelihood score for a particular network output according to the target neural network indicates a likelihood of the network output under the conditional distribution modeled by the target neural network given the network input corresponding to the particular network output. For example, if the target neural network samples a network output y based on the network input x using the conditional distribution p_{θ}, where θ are the target neural network weights, (e.g., y˜p_{θ}(·|x)) the likelihood score for y according to the target neural network can be:

p_{θ}(y|x)

In some implementations, the network outputs can be output sequences. For example, a particular network output, y, may be a sequence of N elements, y=(y₁, . . . , y_{N}). The target neural network can autoregressively generate the output sequences and the likelihood score according to the target neural network for an output y=(y₁, . . . , y_{N}) can be:

$${p}_{θ} ( y \vert x ) = {\prod }_{i = 1}^{N} {p}_{θ} ( {y}_{i} \vert x , {y}_{j < i} )$$

Where p_{θ}(yᵢ|x, y_{j<i}) is the likelihood score of the i-th element, yᵢ according to the target neural network given the network input, x, and the prior elements in the output sequence, y_{j<i}.

In some implementations, the system can determine a likelihood score for each network output according to a reference neural network for the training step (step 508). The reference neural network can be any generative model suited to sampling network outputs conditioned on the network inputs.

For example, the reference neural network can be a network with trained to perform the conditional generation task with a different network architecture compared to the target neural network. As another example, the reference neural network can have the same network architecture as the target neural network. As a further example, the reference neural network can have the same architecture as the target neural network using different (e.g., having been trained with different hyperparameters, performing inference using different hyperparameters, etc.), such as network sizes, network depths, numbers of inputs, learning rates, and so on. As a further example, the reference neural network can be a reparameterization of the target neural network with different network weights or can be a copy of the target neural network as fine-tuned on a particular set of training data for the reference neural network. As a further example, the reference neural network can process modified network inputs compared to the target neural network (e.g., by conditionally generating network outputs based on modified neural network inputs that specify producing the outputs in a different style than the target neural network, by processing modified input prompts compared to the target neural network, etc.).

The likelihood score for a particular network output according to the reference neural network for the time step indicates a likelihood of the network output under the conditional distribution modeled by the reference neural network given the network input corresponding to the particular network output. For example, with q denoting the conditional distribution modeled by the reference neural network, the likelihood score for a network output y given a network input x according to the reference neural network can be:

q(y|x)

The reference neural network for each time step can be determined based on the target neural network. In particular, the reference neural network can have the same network architecture as the target neural network and can have alternative neural network weights determined based on the target neural network weights at the current and previous training steps. As an example, the reference neural network weights can be the target neural network weights from a previous time step (e.g., reference neural network weights at the T-th training step, \hat{θ}_{T}, can be θ_{T-K}, the target neural network weights at the T-K-th time step).

As another example, the reference neural network weights can be determined by a moving average of the target neural network weights at the current and previous training steps. Namely, the reference neural network can model a conditional distribution p_{\hat{θ}}′ (y|x), with the reference neural network weights at the T-th training step, Or, being determined by the moving average:

$${\hat{θ}}_{T} = \frac{1}{K} {\sum }_{i = T - K + 1}^{T} {θ}_{i}$$

Where K>0 is a window length and where θᵢ are the target neural network weights at the i-th training step.

As another example, the reference neural network weights can be determined by an exponential moving average of the target neural network weights at the current and previous training steps. Namely, the reference neural network can model a conditional distribution q_{\hat{θ}}(y|x), with the reference neural network weights at the T-th training step, Or, being determined by the exponential moving average:

$${\hat{θ}}_{T} = {\sum }_{i = 0}^{T} {α}^{T - i} {θ}_{i}$$

Where a α∈[0,1] is a weighting parameter and where θᵢ are the target neural network weights at the i-th training step.

The reference neural network can model a distribution determined by a fixed reference distribution, μ(y|x). When the reference neural network is determined by the fixed reference distribution, μ(y|x), the system can regularize the training of the target neural network using the reference neural network. For example, the fixed reference distribution can be a previously trained neural network that has been verified to produce safe or desirable network outputs.

The reference neural network can model a distribution based on a mixture of the target neural network and the fixed reference distribution, μ(y|x).

As an example, the reference neural network can be determined as an additive mixture between the target neural network and a fixed reference distribution, μ(y|x). For example, with weighting parameter, A ∈[0,1], the reference neural network can be determined following:

$$q ( y \vert x ) = {Ap}_{θ} ( y \vert x ) + ( 1 - A ) μ ( y \vert x )$$

As another example, the reference neural network can be determined as a geometric mixture between the target neural network and a fixed reference distribution, μ(y|x). For example, with a weighting parameter, β∈[0,1], the reference neural network can be determined following:

$$q ( y \vert x ) = \frac{{{p}_{θ} ( y \vert x )}^{1 - β} {μ ( y \vert x )}^{β}}{c ( x )}$$

Where c(x) is a normalizing constant based on the network input x. In particular, c(x) can be defined following:

$$c ( x ) = {\sum }_{{y}^{′}} {{p}_{θ} ( {y}^{′} \vert x )}^{1 - β} {μ ( {y}^{′} \vert x )}^{β}$$

When the network outputs are output sequences, the reference neural network can autoregressively process the output sequences and the likelihood score according to the reference neural network for an output y=(y₁, . . . , y_{N}) can be:

$$q ( y \vert x ) = {\prod }_{i = 1}^{N} q ( {y}_{i} \vert x , {y}_{j < i} )$$

Where q(yᵢ|x, y_{j<i}) is the likelihood score of the i-th element, yᵢ according to the reference neural network given the network input, x, and the prior elements in the output sequence, y_{j<i}.

For example, when the reference neural network is a geometric distribution between the target neural network and a fixed reference distribution, μ(x|y), with a weighting parameter, β∈[0,1], the likelihood score of the i-th element, yᵢ according to the reference neural network can be determined following:

$$q ( y \vert x , {y}_{j < i} ) = \frac{{{p}_{θ} ( y \vert x , {y}_{j < i} )}^{1 - β} {μ ( y \vert x , {y}_{j < i} )}^{β}}{c ( x , {y}_{j < i} )}$$

Where c(x, y_{j<i}) is a normalizing constant based on the network input, x, and the prior elements, y_{j<i}. In particular, c(x) can be defined following:

$$c ( x , {y}_{j < i} ) = {\sum }_{{y}^{′}} {{p}_{θ} ( {y}^{′} \vert x , {y}_{j < i} )}^{1 - β} {μ ( {y}^{′} \vert x , {y}_{j < i} )}^{β}$$

In some implementations, the reference neural network is the alternative neural network.

The system then updates the target neural network using an objective function to perform the conditional sampling task (step 510).

The objective function includes a first term that encourages network outputs from the target neural network to be preferred over the corresponding network outputs from the alternative neural network according to the preference scores.

In some implementations, the objective function can include a second term that penalizes the target neural network for generating network outputs with likelihood scores according to the target neural network that deviate from corresponding likelihood scores according to the reference neural network.

For example, with weighting parameter η∈[0,1], the objective function can be:

$${𝔼}_{x} [ {𝔼}_{y ∼ {p}_{θ} ( \cdot \vert x ) , {y}^{′} ∼ {p}^{′} ( \cdot \vert x )} [ η 𝒫 ( y ≻ {y}^{′} \vert x ) ] - KL ( {p}_{θ} ( \cdot \vert x ) \vert \vert q ( \cdot \vert x ) ) ]$$

Where x are network inputs, p_{θ} is the conditional distribution modeled by the target neural network, p′is the conditional distribution modeled by the alternative neural network, q is the conditional distribution modeled by the reference neural network, [symbol] (y [symbol] y′|x) is the preference score determined for target network output y over alternative network output y′, and KL is the Kullback-Leibler divergence.

The system can determine the objective function as a summation of loss terms for each network input, x. As an example, the system can determine the loss term for target neural network output y and alternative neural network output y′ given network input x following:

$$ℒ ( y , {y}^{′} , x ) = η𝒫 ( y ≻ {y}^{′} \vert x ) - log ( \frac{{p}_{θ} ( y \vert x )}{q ( y \vert x )} )$$

The loss term [symbol] (y [symbol] y′|x) encourages the target neural network to generate outputs that are preferred to those generated by the alternative neural network. The loss term

$$log ( \frac{{p}_{θ} ( y \vert x )}{q ( y \vert x )} )$$

penalizes the target neural network for generating network outputs with likelihood scores according to the target neural network that deviate from corresponding likelihood scores according to the reference neural network.

In some implementations, the system can update the target neural network by computing a gradient of the objective function with respect to the target neural network weights, θ. For example, the system can determine the gradient of the objective function as a sum of gradients of loss terms for each network input, following:

$${∇}_{θ} ℒ ( y , {y}^{′} , x ) = ( {∇}_{θ} log ( {p}_{θ} ( y \vert x ) ) ) ( η𝒫 ( y ≻ {y}^{′} \vert x ) - log ( \frac{{p}_{θ} ( y \vert x )}{q ( y \vert x )} ) )$$

As a particular example, when the preference score, [symbol] (y [symbol] y′|x), is a value between 0 and 1 to indicating a likelihood that y is a higher quality output than y′ and when the reference neural network is a geometric mixture between the target neural network and a fixed reference distribution μ(y|x) with weighting parameter β, the system can determine the gradients of loss terms for each network input following:

$${∇}_{θ} ℒ ( y , {y}^{′} , x ) = ( {∇}_{θ} log ( {p}_{θ} ( y \vert x ) ) ) ( η𝒫 ( y ≻ {y}^{′} \vert x ) - \frac{1}{2} - β log ( \frac{{p}_{θ} ( y \vert x )}{μ ( y \vert x )} ) )$$

The system can update the alternative and reference neural network weights (step 512). The system can determine whether to update the alternative and reference neural network weights based on any of a variety of criteria. For example, the system can update the alternative and reference neural network weights at every training step.

In particular, the system can update the alternative and reference neural network weights using the updated target neural network weights for the training step. For example, if the alternative neural network is determined based on an average of the target neural network weights over multiple time steps, the system can update the alternative neural network weights to include the updated target neural network weights. As another example, if the reference neural network is determined based on an average of the target neural network weights over multiple time steps, the system can update the reference neural network weights to include the updated target neural network weights. As another example, if the reference neural network is determined based on a mixture distribution between the target neural network and a fixed reference distribution, the system can update the mixture distribution for the reference neural network to include the updated target neural network.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers and for training a target neural network that has a plurality of target neural network weights and is configured to process a network input in accordance with the target neural network weights to generate a network output, the method comprising, at each of a plurality of training steps:
receiving one or more network inputs;
for each of the one or more network inputs:
processing the network input using the target neural network to generate a first network output;
processing the network input using an alternative neural network for the training step to generate a second network output; and
applying a preference function to the first network output and the second network output to generate a preference score that indicates a likelihood that the first network output is a higher quality output than the second network output; and
updating the target neural network weights using an objective function that includes a first term that encourages the first network outputs to be preferred over the corresponding second network outputs according to the preference scores.

2. The method of claim 1, the method further comprising, at each of the plurality of training steps and for each of the one or more network inputs:
determining a first likelihood score assigned to the first network output by the target neural network given the network input; and
determining a second likelihood score assigned to the first network output by a reference neural network for the training step given the network input, wherein
the objective function includes a second term that penalizes the target neural network for generating first likelihood scores that deviate from corresponding second likelihood scores.

3. The method of claim 2, wherein, at each of the plurality of training steps, the reference neural network for the training step is the alternative neural network for the training step.

4. The method of claim 1, wherein applying the preference function to the first network output and the second network output to generate the preference score that indicates the likelihood that the first network output is a higher quality output than the second network output comprises:
processing the first network output and the second network output using a preference model neural network to generate a preference network output, wherein the preference model neural network has been trained to process pairs of neural network outputs and generate a corresponding preference network output for each processed pair of neural network outputs that indicates a likelihood that one member of the processed pair is a higher quality output than the other member of the processed pair; and
generating, based on the preference network output, the preference score that indicates the likelihood that the first network output is a higher quality output than the second network output.

5. The method of claim 2 wherein, at each of the plurality of training steps and for each of the one or more network inputs, determining the second likelihood score assigned to the first network output by a reference neural network for the training step given the network input comprises:
determining the second likelihood score assigned to the first network output based on a geometric mixture of the first likelihood score for the first network output and of a likelihood score for the first network output under a fixed reference distribution and based on a normalizing constant for the training step.

6. The method of claim 1, wherein, at each of the plurality of training steps:
the alternative neural network for the training step has a plurality of alternative neural network weights for the training step and has the same architecture as the target neural network; and
the alternative neural network weights for the training step are determined by an exponential moving average of the target neural network weights over the current and previous training steps.

7. The method of claim 1, wherein the objective function is based on, for each network input and corresponding first and second network outputs:
a preference score, as determined by the preference function, indicating a likelihood that the first network output is a higher quality output than the second network output;
a first likelihood score for the first network output, as determined by the target neural network; and
a second likelihood score for the first network output, as determined by a fixed reference distribution.

8. The method of claim 1, wherein updating the current target neural network weights using the objective function that includes a first term that encourages first network inputs to be preferred over corresponding second network inputs according to the preference scores comprises:
determining a gradient of the objective function with respect to the target neural network weights; and
updating the target neural network weights based on the gradient of the objective function.

9. The method of claim 8, wherein determining the gradient of the objective function with respect to the current target neural network weights comprises computing for each network input and corresponding first and second network outputs:
a gradient of a first likelihood score for the first network output, as determined by the target neural network, with respect to the current target neural network weights; and
a preference score, as determined by the preference function, indicating a likelihood that the first network output is a higher quality output than the second network output;
the first likelihood score for the first network output, as determined by the target neural network; and
a likelihood score for the first network output, as determined by a fixed reference distribution.

10. The method of claim 1, wherein the target neural network is a large language model.

11. The method of claim 1, wherein the preference neural network is a large language model.

12. The method of claim 2, wherein:
the first network output comprises a first network output sequence;
the second network output comprises a second network output sequence; and
processing the network input using the alternative neural network to generate the second network output comprises autoregressively generating the second network output sequence using the alternative neural network.

13. The method of claim 12, wherein, at each of the plurality of training steps and for each of the one or more network inputs, determining the second likelihood score assigned to the first network output by a reference neural network for the training step given the network input comprises:
for each output element of the first network output sequence:
determining a first likelihood score for the output element given the network input using the target neural network; and
determining a second likelihood score for the output element based on a geometric mixture of the first likelihood score for the output element and of a likelihood score for the output element under a fixed reference distribution and based on a normalizing constant for the training step; and
determining the second likelihood score assigned to the first network output based on the second likelihood scores of the output elements in the first network output sequence.

14. The method of claim 1, wherein the preference function can model a non-transitive preference relation.

15. A system comprising:
one or more computers; and
one or more storage devices communicatively coupled to the one or more computers, wherein the one or more storage devices store instructions that, when executed by the one or more computers, cause the one or more computers to perform operations for training a target neural network that has a plurality of target neural network weights and is configured to process a network input in accordance with the target neural network weights to generate a network output, the operations comprising, at each of a plurality of training steps:
receiving one or more network inputs;
for each of the one or more network inputs:
processing the network input using the target neural network to generate a first network output;
processing the network input using an alternative neural network for the training step to generate a second network output; and
applying a preference function to the first network output and the second network output to generate a preference score that indicates a likelihood that the first network output is a higher quality output than the second network output; and
updating the target neural network weights using an objective function that includes a first term that encourages the first network outputs to be preferred over the corresponding second network outputs according to the preference scores.

16. One or more non-transitory computer storage media storing instructions that when executed by one or more computers cause the one or more computers to perform operations for training a target neural network that has a plurality of target neural network weights and is configured to process a network input in accordance with the target neural network weights to generate a network output, the operations comprising, at each of a plurality of training steps:
receiving one or more network inputs;
for each of the one or more network inputs:
processing the network input using the target neural network to generate a first network output;
processing the network input using an alternative neural network for the training step to generate a second network output; and
applying a preference function to the first network output and the second network output to generate a preference score that indicates a likelihood that the first network output is a higher quality output than the second network output; and
updating the target neural network weights using an objective function that includes a first term that encourages the first network outputs to be preferred over the corresponding second network outputs according to the preference scores.

17. The one or more non-transitory computer storage media of claim 15, the operations further comprising, at each of the plurality of training steps and for each of the one or more network inputs:
determining a first likelihood score assigned to the first network output by the target neural network given the network input; and
determining a second likelihood score assigned to the first network output by a reference neural network for the training step given the network input, wherein
the objective function includes a second term that penalizes the target neural network for generating first likelihood scores that deviate from corresponding second likelihood scores.

18. The one or more non-transitory computer storage media of claim 15, wherein applying the preference function to the first network output and the second network output to generate the preference score that indicates the likelihood that the first network output is a higher quality output than the second network output comprises:
processing the first network output and the second network output using a preference model neural network to generate a preference network output, wherein the preference model neural network has been trained to process pairs of neural network outputs and generate a corresponding preference network output for each processed pair of neural network outputs that indicates a likelihood that one member of the processed pair is a higher quality output than the other member of the processed pair; and
generating, based on the preference network output, the preference score that indicates the likelihood that the first network output is a higher quality output than the second network output.

19. The one or more non-transitory computer storage media of claim 15, wherein the objective function is based on, for each network input and corresponding first and second network outputs:
a preference score, as determined by the preference function, indicating a likelihood that the first network output is a higher quality output than the second network output;
a first likelihood score for the first network output, as determined by the target neural network; and
a second likelihood score for the first network output, as determined by a fixed reference distribution.

20. The one or more non-transitory computer storage media of claim 15, wherein the preference function can model a non-transitive preference relation.
